(19) United States
(12) Patent Application Publication
(10) Pub. No.: US 2006/0257803 A1
(43) Pub. Date: Nov. 16, 2006

(54) Gas valve controller

(75) Inventors: John Schlachter, Leonard, MI (US); Lynn E. Cooper, Fort Worth, TX (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: Maxitrol Company, Southfield, MI (US)

(21) Appl. No.: 11/403,539

(22) Filed: Apr. 13, 2006

Related U.S. Application Data
(60) Provisional application No. 60/670,795, filed on Apr. 13, 2005.

(51) Int. Cl. A01G 13/06

(52) U.S. Cl. 431/18

(57) ABSTRACT

A gas valve (22) control system (10) for a heater includes a burner (26) and a valve (22) that has a high flow stage and a low flow stage. The valve (22) supplies fuel to the burner (26) in the high flow stage until the burner (26) is ignited. While operating in the high flow stage, an inducer (24) that supplies combustion air to the burner (26) operates in a high speed stage. The valve (22) and the inducer (24) are controlled by a controller (12). A timer (28) is used to coordinate the valve (22) and the inducer (24) such that after a predetermined amount of time, the valve (22) switches to a low flow stage and the inducer (24) switches to a low speed stage. This is to provide the burner (26) with more fuel and combustion air while igniting and to reduce condensation in the heater.

### CROSS REFERENCE TO RELATED APPLICATION

This application claims the benefit of provisional patent application Ser. No. 60/670,795 filed Apr. 13, 2005.

### BACKGROUND OF THE INVENTION

1. Field of the Invention

The present invention is a gas valve control system.

2. Description of the Prior Art

Various gas valve control systems are known in the prior art and are used in various applications, like heaters. The gas valve control systems of the prior art include a controller to communicate signals between external sensors and the heater. The signals generated by the controller operate a valve that regulates flow of a fuel to a burner. The burner receives the fuel from the valve and when ignited, the burner creates heat. An inducer is used in the heater to provide combustion air to the burner and vent fumes created by the burner.

The valve and the inducer may have more than one operating stage. For example, the valve may have a low flow stage and a high flow stage. Likewise, the inducer may have a low speed stage and a high speed stage. The valve operates in the high flow stage when more heat is desired, and the inducer operates in the high speed stage when more combustion air is needed at the burner. Once the burner has heated the air in the heater, a blower is responsible for moving the heated air. In order to prevent the blower from moving cool air, the blower is delayed by a timer to allow the air in the heater to heat before it is circulated.

Although used in various applications, there remains an opportunity to improve upon the gas valve control systems of the prior art. Specifically, the prior art gas valve control systems may be improved to add versatility so that the gas valve control system can work with various types of valves and ignition controllers. In addition, it is important to provide a gas valve control system that is adaptable and programmable. Furthermore, gas valve control systems may be improved to add efficiency when igniting the burner and to reduce problems associated with condensation.

### SUMMARY OF THE INVENTION AND ADVANTAGES

The subject invention is a gas valve control system for a heater. The system includes a burner and a valve. The valve has a high flow stage and a low flow stage and is operatively connected to the burner for providing the burner with a fuel. An inducer has a high speed stage and a low speed stage and is operatively connected to the burner for providing the burner with combustion air. A controller is electrically connected to the heater and generates a control signal. A timer is electrically connected between the controller and both of the valve and the inducer for coordinating the valve and the inducer and simultaneously switching the valve between the high flow stage and the low flow stage and the inducer between the high speed stage and the low speed stage after a predetermined delay time has elapsed.

The gas valve control system of the present invention has advantages over the prior art systems. Specifically, the gas valve control system of the present invention provides greater control of the valve and the inducer, which increases efficiency when lighting the burner and reduces condensation caused by inadequate preheating. Specifically, the present invention allows the valve and the inducer to be linked together so that the valve operates in the high flow stage at the same time the inducer operates in the high speed stage and the valve operates in a low flow stage at the same time the inducer operates in the low speed stage.

### BRIEF DESCRIPTION OF THE DRAWINGS

Other advantages of the present invention will be readily appreciated, as the same becomes better understood by reference to the following detailed description when considered in connection with the accompanying drawing wherein:

FIG. 1 is a drawing of an environment having a gas valve control system assembled in accordance with the subject invention;

FIG. 2 is a schematic of a gas valve control system assembled in accordance with the subject invention; and

FIG. 3 is a drawing of a valve used in the gas valve control system in accordance with the subject invention.

### DETAILED DESCRIPTION OF THE INVENTION

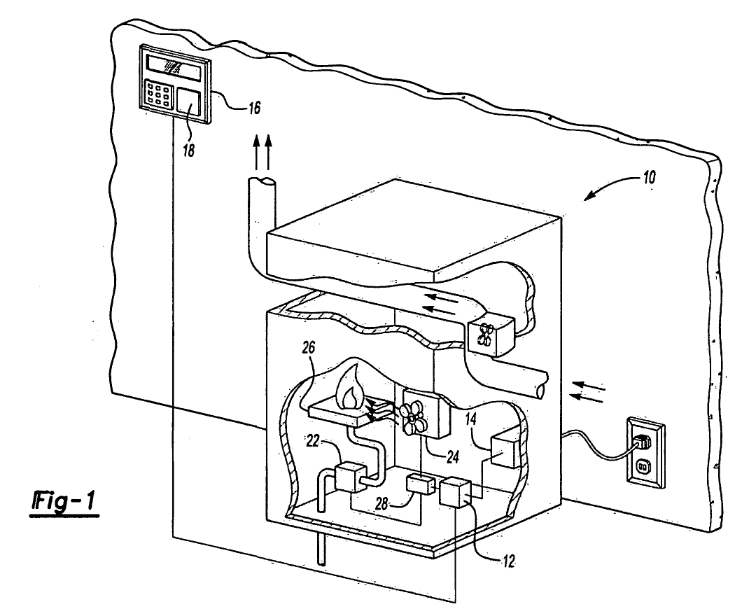

Referring to FIGS. 1-3, a gas valve control system is shown generally at 10. The gas valve control system 10 includes a controller 12 that is electrically connected to a power supply 14 that provides the controller 12 with electrical energy. The power supply 14 is any device capable of supplying electrical energy to the controller 12. For example, the controller 12 may operate with a 24 VAC source. Since many outlets provide 120 VAC, the power supply 14 may include a step down transformer that reduces the 120 VAC from the outlet to 24 VAC. It should be understood that the voltages provided are merely exemplary, and the controller 12 may be operated with other voltages.

A temperature control module 16 is mounted to a wall and is electrically connected to the controller 12. A temperature sensor 18 is in communication with the temperature control module 16. The temperature sensor 18 is located in an environment and is used to measure a temperature of the environment. The environment includes any enclosed space where temperature control may be utilized, such as, but not limited to, a room or building. The temperature is compiled into a direct current signal by the temperature sensor 18 and then transmitted to the temperature control module 16. The temperature control module 16 processes the temperature to determine whether the environment needs to be heated. In doing so, the temperature control module 16 compares the temperature of the environment to a predetermined temperature range set for the environment. If the temperature is below the predetermined temperature range, a temperature control signal is transmitted from the temperature control module 16 to the controller 12 instructing the gas valve control system 10 to generate heat. The temperature control signal is indicative of the difference between the temperature in the environment and the predetermined temperature range set for the environment.

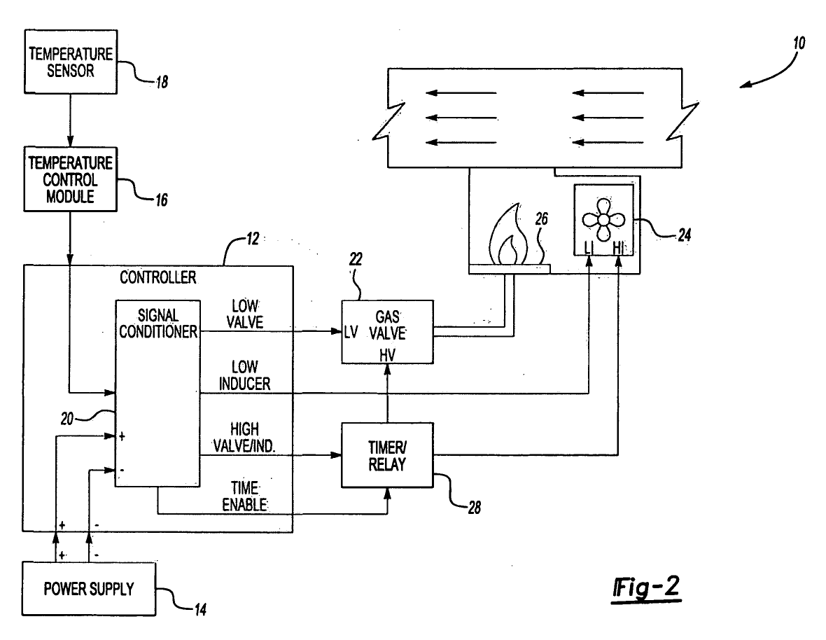

As shown in FIG. 2, the controller 12 includes a signal conditioner 20 that receives the temperature control signal from the temperature control module 16 and creates a control signal to operate various components in the gas valve control system 10. In order to provide the most efficiency when heating, the control signal generated by the signal conditioner 20 is directly proportional to the temperature control signal. Therefore, a greater difference between the temperature in the environment and the predetermined temperature range will result in the gas valve control system 10 calling for a greater increase in heat. If the temperature of the environment is below the predetermined temperature range, the controller 12 responds by generating the control signal that will heat the environment. On the other hand, if the temperature of the environment is above the predetermined temperature range, the controller 12 responds by generating the control signal that will cool the environment. In certain instances, it is acceptable for the temperature to be above the predetermined temperature range, but not below, such as when used with a heater to heat the environment. If the temperature is within the predetermined temperature range, then the temperature control module 16 refrains from sending the temperature control signal to the controller 12.

As previously stated, the control signal is generated by the controller 12 to operate various components used in the gas valve control system 10 that change the temperature in the environment. The various components are housed in the heater and may use different signals than the temperature control signal, making the temperature control signal incompatible with the various components. The signal conditioner 20 adjusts the temperature control signal into the control signal that is compatible with the various components in the gas valve control system 10. The control signal is directly proportional to the temperature control signal and may be a multiple of the temperature control signal.

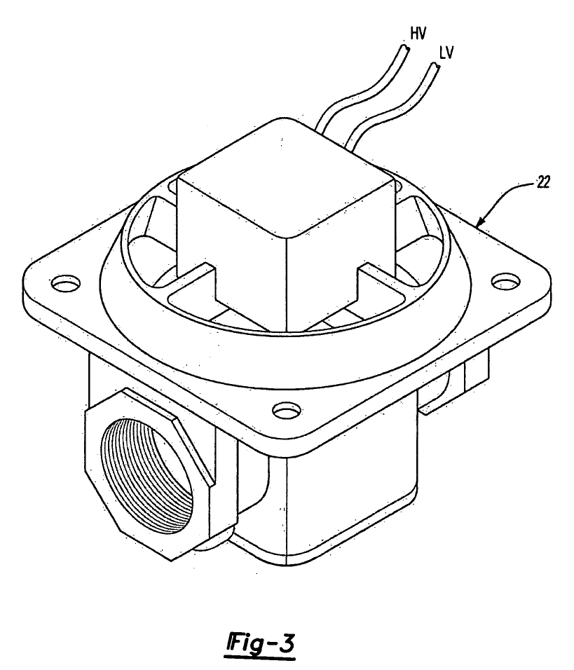

The various components used with the gas valve controller 12 that are housed in the heater include but are not limited to a valve 22, an inducer 24, and a burner 26. First, the valve 22, shown generally in FIG. 3, is in fluid communication with a fuel source so that the valve 22 may provide fuel to the burner 26. Referring to FIGS. 1-3, the valve 22 has two operating stages: a low flow stage and a high flow stage. In the low flow stage, a plunger disposed inside the valve 22 restricts fluid flow through the valve. In the high flow stage, the plunger allows more fluid to flow through the valve 22. Each stage corresponds to an electrical input located on the valve 22. The electrical inputs HV, LV of the valve 22 include a low valve input LV that enables the low flow stage of the valve 22 and a high valve input HV that enables the high flow stage of the valve 22. The controller 12 is electrically connected to the low valve input LV that enables the low flow stage of the valve 22. The control signal that is transmitted from the controller 12 to the valve 22 is a valve control signal. The valve control signal is generated by the controller 12 and is within a range of voltages or currents that may be used to control the valve 22. For example, the valve 22 may be a modulating valve that regulates fluid flow based on the voltage or current supplied to it. The valve 22 may operate such that as more voltage or current is supplied to the low valve input LV, more fuel reaches the burner 26. The high flow stage of the valve 22 may simply be used to open the valve 22 completely. Once the high valve input HV is enabled, the valve 22 opens to allow the maximum amount of fuel to reach the burner 26.

Similarly, the inducer 24 is located in the heater and is used to provide the burner 26 with combustion air. Like the valve 22, the inducer 24 operates in two stages: a low speed stage and a high speed stage. The inducer 24 also has two electrical inputs HI, LI that correspond to one of the low speed stage and the high speed stage. The electrical inputs HI, LI of the inducer 24 include a low inducer input LI that enables the low speed stage of the inducer 24 and a high inducer input HI that enables the high speed stage of the inducer 24. When the burner 26 is operating in a steady state, the inducer 24 operates in the low speed stage to provide the burner 26 with enough combustion air to keep the burner 26 ignited. In addition, the inducer 24 eliminates exhaust generated by the burner 26 by circulating the exhaust away from the heater. The controller 12 is electrically connected to the low inducer input LI that enables the low speed stage of the inducer 24. The control signal that is transmitted from the controller 12 to the inducer 24 is an inducer control signal. Similar to the valve 22, the inducer 24 may also operate proportional to the voltage or current supplied to the low inducer input LI. Therefore, as more voltage or current is used to enable the inducer 24 at the low inducer input LI, more combustion air reaches the burner 26. In addition, the high speed stage of the inducer 24 may be enabled for the inducer 24 to provide the burner 26 with the maximum amount of combustion air.

Generally, the valve 22 operates in the low flow stage and the inducer 24 operates in the low speed stage during steady state operation. However, when igniting the burner 26, it is advantageous to operate the valve 22 in the high flow stage and the inducer 24 in the high speed stage to provide adequate amounts of combustion air and fuel to the burner 26 and to reduce condensation, but it may be inefficient to continue to operate the valve 22 in the high flow stage and the inducer 24 in the high speed stage after the burner 26 is lit and the heater is adequately heated. Therefore, it is advantageous to operate the valve 22 in the low flow stage and the inducer 24 in the low speed stage after a predetermined delay time.

In order to switch between the stages of the valve 22 and the inducer 24 after the predetermined delay time, the gas valve control system 10 employs a timer 28. The timer 28 receives the control signal from the controller 12 and transmits the control signal to the heater to enable the high flow stage of the valve 22 and the high speed stage of the inducer 24. After the predetermined delay time has elapsed, the timer 28 disables the high flow stage of the valve 22 and the high speed stage of the inducer 24, causing the valve 22 to operate in the low flow stage and the inducer 24 to operate in the low speed stage. In order to accomplish this, the timer 28 may be a relay that has physical characteristics that allow the control signal to pass through the timer 28 for the predetermined delay time until the relay opens. The predetermined delay time may be adjusted by using a potentiometer, and the predetermined delay time should be long enough to allow the burner 26 to ignite and heat the heater to reduce condensation. It should be understood that various types of relays may be used with the gas valve control system 10. For example, it may be advantageous for the relay to be normally open and close only after the predetermined delay time has elapsed. On the other hand, it may be advantageous for the relay to be normally closed and open only after the predetermined delay time has elapsed. By way of example, the relay used herein is a normally closed relay that opens after the predetermined delay time has elapsed. Further, the relay opens when it receives a signal below a certain threshold voltage. For example, the relay opens when the controller 12 transmits the control signal to the timer 28 below 4.7 VDC. Likewise, the relay closes when it receives a signal above a certain threshold voltage. For example, the relay closes when the controller 12 transmits the control signal to the timer 28 above 5.3 VDC. It should be understood that the relay may open and close at different voltages than indicated, and alternatively, the relay may open and closed based on a threshold of currents as opposed to voltages.

Referring specifically to the gas valve control system 10 of the subject invention, the timer 28 is electrically connected to the high valve input HV to enable the high flow stage of the valve 22 and the high inducer input HI to enable the high speed stage of the inducer 24. The timer 28 transmits the valve control signal to the high valve input HV and the inducer control signal to the high inducer input HI. When operating in the high flow stage, the valve 22 allows a greater amount of fuel to flow from the fuel source to the burner 26 than when the valve 22 is operating in the low flow stage. In order to ignite the burner 26, it is important for the inducer 24 to provide the burner 26 with sufficient combustion air, so when the valve 22 is allowing more fuel to reach the burner 26, the inducer 24 operates in the high speed stage so that more combustion air can reach the burner 26 than when the inducer 24 operates in the low speed stage. After enough fuel and combustion air have been provided to ignite the burner 26, and after the burner 26 has generated enough heat to reduce condensation in the heater, the valve 22 and the inducer 24 can reduce the amount of fuel and combustion air without the burner 26 extinguishing. Since the predetermined delay time is related to the time needed to ignite the burner 26 and heat the heater adequately to reduce condensation, after the predetermined delay time has elapsed, the relay opens, which prevents the valve control signal from enabling the high flow stage of the valve 22 and the inducer control signal from enabling the high speed stage of the inducer 24, thus causing the valve 22 to operate in the low flow stage and the inducer 24 to operate in the low speed stage.

By way of example, the temperature sensor 18 reads the temperature in the environment and transmits the temperature to the temperature control module 16. The temperature control module 16 then generates the temperature control signal based on the temperature increase needed. The temperature control module 16 compares the temperature in the environment read by the temperature sensor 18 to the predetermined range of temperatures to find the temperature increase needed and create the temperature control signal. Due to the characteristics of the temperature control module 16, the temperature control signal may range between 0 VDC and 10 VDC with each voltage in the range corresponding to a different temperature, i.e. a 20 degree increase in temperature may correspond to a 5 VDC signal when a starting temperature is 30 degrees. In this example, a 20 degree temperature increase would cause the temperature control module 16 to output a temperature control signal of 5 VDC to the controller 12. It should be appreciated that any voltage or range of voltages may correspond to any temperature or range of temperatures, or alternatively, any current or range of currents may correspond to any temperature or range of temperatures.

Once the temperature control signal is generated that corresponds with the temperature increase needed, the signal conditioner 20 is used to scale the temperature control signal to a voltage or current that is compatible with the valve 22, the inducer 24, and the timer 28. Using the previous example, once the temperature control module 16 calls for a temperature increase of 20 degrees, and the controller 12 responds by enabling the high flow stage of the vale and the high speed stage of the inducer 24 through the timer 28 to ignite the burner 26. The signal conditioner 20 scales the 5 VDC signal corresponding to a 20 degree increase to a 5.3 VDC signal to close the relay. If the relay is normally closed, this step may not be necessary. Closing the relay enables the high flow stage of the valve 22 and the high speed stage of the inducer 24, which helps to ignite the burner 26. Once the burner 26 has been ignited, the condensation has been reduced, and after the predetermined amount of time has passed, the relay opens, which disables the high flow stage of the valve 22 and the high speed stage of the inducer 24.

When the high flow stage of the valve 22 and the high speed stage of the inducer 24 are disabled, the controller 12 enables the low flow stage of the valve 22 and the low flow stage of the inducer 24 so that the burner 26 will remain lit. However, the valve 22 and the inducer 24 may operate at a different range of voltages or currents than that generated by the temperature control module 16. Referring to the previous example, the temperature control module 16 generates the temperature control signal between 0 VDC and 10 VDC, and a temperature increase of 20 degrees is indicated by a temperature control signal of 5 VDC. In contrast, the valve 22 and the inducer 24 may operate between 0 VDC and 20 VDC, and the valve 22 and the inducer 24 may recognize the temperature increase of 20 degrees with the control signal being 10 VDC. This results in the temperature increase indicated by the temperature control signal being incompatible with the valve 22 and the inducer 24. Therefore, the signal conditioner 20 scales the temperature control signal of 5 VDC corresponding to a 20 degree temperature increase to a control signal of 10 VDC in order to drive the valve 22 and the inducer 24 to produce sufficient fuel and combustion air to allow the burner 26 to heat the heater enough to increase the temperature by 20 degrees. In another example, the starting temperature may be 50 degrees, and the temperature control signal for an increase of 20 degrees may be 8 VDC. The control signal to drive the valve 22 and the inducer 24 to an increase of 20 degrees with a starting temperature of 50 degrees may be 16 VDC. It should be understood that these voltages are merely exemplary in nature, and any temperature range could correspond to any range of voltage or current.

When the valve 22 is operating in the low flow stage and the inducer 24 is operating in the low speed stage, the gas valve controller 12 may call for an increase in heat. In this case, the controller 12 closes the relay, which enables the high flow stage of the valve 22 and the low flow stage of the inducer 24. The timer 28 may be configured such that the relay will open after the predetermined delay time, but will close with no delay. This may be advantageous with a relay that is normally closed and opens to disable the high flow stage of the valve 22 and the high speed stage of the inducer 24. Alternatively, the timer 28 may be configured such that the relay will close after the predetermined delay time, but will open with no delay. This embodiment may be advantageous with a relay that is normally open and closes to disable the high flow stage of the valve 22 and the high speed stage of the inducer 24. In yet another alternative, the gas valve controller 12 may be configured such that the delay only occurs when igniting the burner 26 and no delay would occur when otherwise switching between the stages of the valve 22 and the inducer 24.

Obviously, many modifications and variations of the present invention are possible in light of the above teachings. The invention may be practiced otherwise than as specifically described within the scope of the appended claims.

What is claimed is:

1. A gas valve control system for a heater, said system comprising:
a burner,
a valve having a high flow stage and a low flow stage and operatively connected to said burner for providing said burner with a fuel,
an inducer having a high speed stage and a low speed stage and operatively connected to said burner for providing said burner with combustion air;
a controller electrically connected to the heater for generating a control signal; and
a timer electrically connected between said controller and both of said valve and said inducer for coordinating said valve and said inducer and simultaneously switching said valve between said high flow stage and said low flow stage and said inducer between said high speed stage and said low speed stage after a predetermined delay time has elapsed.

2. A system as set forth in claim 1 wherein said timer links said high flow stage of said valve to said high flow stage of said inducer and said low flow stage of said valve to said low flow stage of said inducer such that said valve operates in said high flow stage when said inducer operates in said high speed stage and said valve operates in said low flow stage when said inducer operates in said low speed stage.

3. A system as set forth in claim 1 wherein said timer is further defined as a relay.

4. A system as set forth in claim 1 wherein said valve includes a low valve input electrically connected to at least one of said controller and said timer for enabling said low flow stage of said valve.

5. A system as set forth in claim 1 wherein said valve includes a high valve input electrically connected to at least one of said controller and said timer for enabling said high flow stage of said valve.

6. A system as set forth in claim 1 wherein said inducer includes a low inducer input electrically connected to at least one of said controller and said timer for enabling said low speed stage of said inducer.

7. A system as set forth in claim 1 wherein said inducer includes a high inducer input electrically connected to at least one of said controller and said timer for enabling said high speed stage of said inducer.

8. A system as set forth in claim 1 further including a temperature sensor electrically connected to said controller for measuring a temperature in an environment.

9. A system as set forth in claim 8 further including a temperature control module electrically connected between said sensor and said controller for converting the temperature into a temperature control signal.

10. A system as set forth in claim 9 further including a signal conditioner electrically connected to said controller for converting the temperature control signal into a valve control signal that enables said valve and an inducer control signal that enables said inducer.
